(19) United States
(12) Patent Application Publication
(10) Pub. No.: US 2021/0365126 A1
(43) Pub. Date: Nov. 25, 2021

(54) SELECTIVELY REMOVABLE KEYBOARD BASES

(71) Applicant: Hewlett-Packard Development Company, L.P., Spring, TX (US)

(72) Inventor: Jiaqi Zou, Houston, TX (US)

(73) Assignee: Hewlett-Packard Development Company, L.P., Spring, TX (US)

(21) Appl. No.: 17/048,142

(22) PCT Filed: Sep. 7, 2018
(86) PCT No.: PCT/US2018/049848

§ 371 Date: Oct. 16, 2020

(51) Int. Cl. G06F 3/02; G06F 3/0338; G06F 3/041; G06F 3/0354; G06F 3/038; G06F 3/023; G06F 1/16

(52) U.S. Cl. CPC G06F 3/0213; G06F 3/0338; G06F 3/041; G06F 3/0354; G06F 3/0221; G06F 1/1669; G06F 3/023; G06F 1/1681; G06F 1/1654; G06F 1/169; G06F 3/038

(57) ABSTRACT

A computer input device that includes a keyboard base comprising a touch-sensitive display device and selectively removable from a keyboard and a joystick couplable to the touch-sensitive display device.

### BACKGROUND

Computing devices work with input from a user. Input may be provided so that the user may cause computer executable program code to be executed. A number of types of input devices may be used in order to allow a user to interface with the execution of this computer executable program code.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a computer input device according to an example of the principles described herein.

FIG. 2 is a block diagram of a computing system according to an example of the principles described herein.

FIG. 3 is a block diagram of computer input device according to an example of the principles described herein.

FIG. 4 is a flowchart showing a method of determining a configuration state of a computing system according to an example of the principles described herein.

FIG. 5 is a block diagram of a computing system according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A computing device may include any number of input devices that allow the user to interact with the computing device. The input devices may provide data and control signals to a processing device of a computing device. Certain input devices may include keyboards, mice, scanners, digital cameras, and joysticks. among others. However, ever increasing numbers of types of input devices may be created to allow the user to interface with the computing device.

The present specification describes a computer input device that includes a keyboard base comprising a touch-sensitive display device and selectively removable from a keyboard and a joystick couplable to the touch-sensitive display device.

The present specification also describes a computing system that includes a processor; a display device; a keyboard selectively coupled to the display device; a separable base portion of the keyboard comprising a touch-sensitive display device; and a mouse comprising two removable joysticks.

The present specification further describes a keyboard that includes a separable base portion, the separable base portion being electrically and mechanically couplable to the keyboard, wherein the separable base portion includes a hinge to fold the separable base portion on itself; and a touchscreen display formed on a portion of the separable base portion; wherein folding a portion of the separable base portion exposed by folding the separable base portion at the hinge exposes a mechanical interface to receive a joystick.

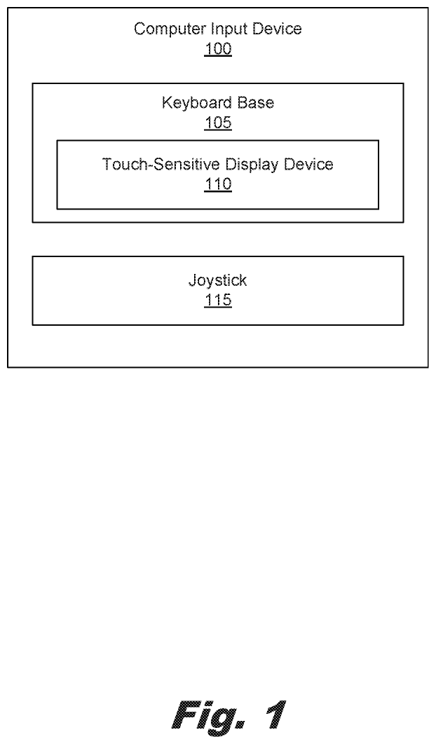

Turning now to the figures, FIG. 1 is a block diagram of a computer input device (100) according to an example of the principles described herein. The computer input device (100) may include a keyboard base (105) including a touch-sensitive display device (110) and a joystick (115).

The keyboard base (105) may be a portion of a keyboard of a computing device. In an example, the portion of the keyboard forming the keyboard base (105) may be a section of the keyboard proximal to a user. In any example presented herein, the keyboard base (105) may be selectively coupled to the keyboard. The coupling of the keyboard base (105) to the keyboard may be accomplished via any type of coupling device. Among these coupling devices may include screws, latches, magnets, straps, locks, and snaps, among other types of coupling devices. In an example, when the keyboard base (105) is coupled to a keyboard, an electrical/signal connection may be made between the keyboard base (105) and the keyboard such that input from the keyboard base (105) may be received by the keyboard and/or processor of a computing device associated with the keyboard.

In any example presented herein, the keyboard base (105) may include a keyboard base processor to execute computer readable program code. In this example, the keyboard base (105), whether coupled to the keyboard or not, may execute computer-readable program code. In the example where the keyboard base (105) is coupled to the keyboard, the keyboard base processor may process computer executable program code independent of or in cooperation with a processor of the computing device. In the example where the processor of the keyboard base (105) cooperates with the processor of the computing device, such a cooperation may increase the computational power of the system as a whole. This may be done by, for example, annexing the CPU and/or GPU of the keyboard base (105) by the processor of the computing device. Consequently, the keyboard base (105) may be treated as not only an input device, but also an external CPU/GPU with heterogenous multi-core capabilities.

In the example where the keyboard base (105) is uncoupled from the keyboard, the keyboard base (105) may execute computer-readable program code independent of a processor associated with the computing device. In an example, the keyboard base (105) may further include a data storage device to maintain the computer executable program code thereon. In an example, the data storage device may include a micro-SD card maintained in a micro-SD card slot. In an example, the data storage device may include various types of memory modules, including volatile and nonvolatile memory. For example, the data storage device (102) of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage purposes. For example, in certain examples the keyboard base processor may boot from Read Only Memory (ROM), maintain nonvolatile storage in the Hard Disk Drive (HDD) memory, and execute program code stored in Random Access Memory (RAM).

Generally, the data storage device may comprise a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The keyboard base (105) may include a touch-sensitive display device (110). In an example, the touch-sensitive display device (110) may receive input to a processor of the computing device associated with the keyboard when the keyboard base (105) is coupled to the keyboard. In an example, the touch-sensitive display device (110) may display any number of user interface icons to the user describing actions that a user may engage in. For example, when the keyboard base (105) with the touch-sensitive display device (110) is coupled to a keyboard, a processor of the computing device associated with the keyboard may present a list of icons or actions representing computer executable program code that may, for example, launch applications such as word processing applications, email applications, drawing applications, spreadsheet applications, and gaming applications among other types of computer applications. In an example, the entirely of or a portion of the touch-sensitive display device (110) may be used as trackpad device that, when contacted by a finger of a user, tracks x and y coordinates on the trackpad to x and y coordinates on a display device of a computing device allowing a user to move a cursor on the display device. In a further example, a user may actuate a button associated with the computing device in order to selectively switch the touch-sensitive display device (110) between the icon display mode described herein to this track pad mode. In any example, the touch-sensitive display device (110) may receive input from a user selecting these icons or actions to be executed. In an example, the touch-sensitive display device (110) may be a light-emitting diode (LED) display device, an organic light-emitting diode (OLED) display device, and a liquid crystal display (LCD) device, among other types of display devices.

The keyboard base (105), in any example presented herein, may further include a battery device or other type of electrical storage device. The electrical storage device may power the keyboard base (105) when the keyboard base (105) is removed from the keyboard and, therefore, removed from a power source associated with the keyboard. Consequently, the keyboard base (105) may include its own dedicated power source and processing source so as to operate independent of a keyboard from which it was decoupled from or a computing device.

In an example, the keyboard base (105) may include a number of interfaces used to interface with a number of joysticks (115). The interfaces may be a mechanical and/or electrical interface that receives the joystick (115). In an example, the number of interfaces may be two that can receive two individual joysticks (115); one joystick (115) on either side of the touch-sensitive display device (110) of the keyboard base (105). In this example, each joystick (115) may be coupled to the keyboard base (105) on left and right sides of the keyboard base (105) so that the user may interface with the keyboard base (105) while viewing the touch-sensitive display device (110).

In an example, the keyboard base (105) may include a number of hinges to fold a portion or portions of the keyboard base (105) on itself. In this example, the interfaces used to interface the keyboard base (105) with the joystick (115) or joysticks (115) may be presented. In this example, a locking mechanism may be used to lock the foldable portions of the keyboard base (105) in the open position in order to allow a user to interface the joysticks (115) with the revealed interfaces on the keyboard base (105).

The joysticks (115) may also include an interface that mechanically and/or electrically interfaces with the interfaces formed on the keyboard base (105) as described herein. In an example, the joysticks (115) may include a wireless communication interface in order to wirelessly communicate with the keyboard base (105). In an example, the interface between the joysticks (115) and the keyboard base (105) may be wired implementing a number of electrical contact pads that allows signals to pass to and from the joysticks (115) to the keyboard base (105) when the joysticks (115) are interfaced with the interfaces formed on the keyboard base (105).

In an example presented herein, the joysticks (115) may fora part of a mouse. In this example, the joysticks (115) may include a mechanical interface that physically couples the joysticks (115) to a housing of the mouse. In an example, the housing of each of the joysticks (115) may form part of the housing of the mouse when the joysticks (115) are interfaced with the mouse.

Thus, during use, a user may decouple the keyboard base (105) from the keyboard. In the example where the keyboard base (105) does not include the hinges described herein, the user may remove the joysticks (115) from the mouse and interface the joysticks (115) with the interfaces formed on the keyboard base (105) used to receive the joysticks (115). In the example where the keyboard base (105) includes hinges, the user may fold the keyboard base (105) on itself at those hinges revealing the mechanical and/or electrical interface on the keyboard base (105). In this example, the user may remove the joysticks (115) from the mouse and interface the joysticks (115) with the keyboard base (105) as described herein. This allows a user to remove the keyboard base (105) from the keyboard and engage in an activity associated with the keyboard base (105) such as gaming while the processes associated with the keyboard and its computing device may continue.

In an example, the processes of the computing device once engaged in by the user may be continued on the keyboard base (105) once the user removes the keyboard base (105) from the computing device. In this example, the processor executing any process on the computing device may be mirrored on the keyboard base (105). In another example, the processor of the computing device may hand over processes being execute on the computing device to the processor of the keyboard base (105) when the keyboard base (105) is removed from the keyboard. In an example, once the keyboard base (105) is recoupled with the keyboard, the processor of the computing device may take over processing of any computer executable program code.

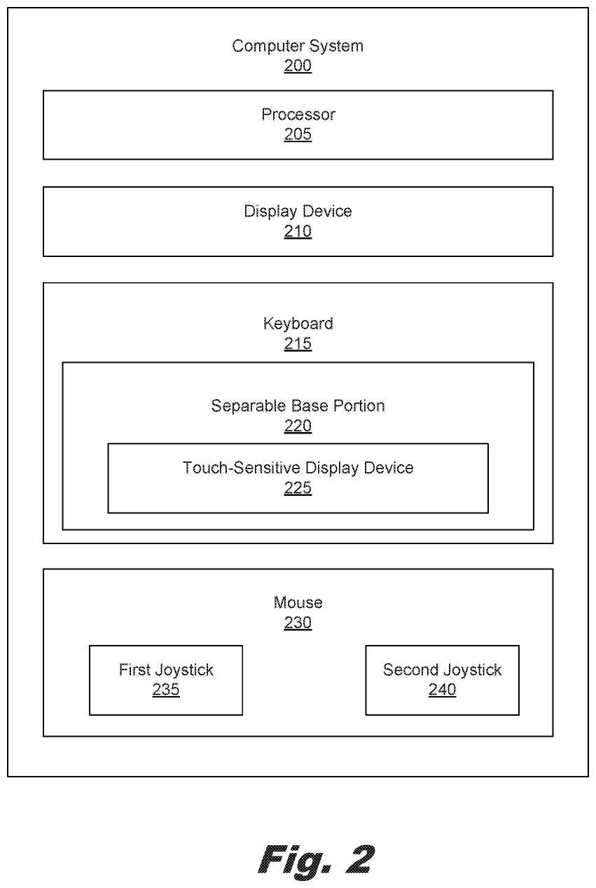

FIG. 2 is a block diagram of a computing system (200) according to an example of the principles described herein. The computing system (200) may include a processor (205). This processor (205) may include any type of processing device that allows the computing system (200) to execute computer readable program code. In an example, the processor (205) may determine the state of the separable base portion (220) of the keyboard (215) relative to the keyboard (215). In particular, the processor (205) may receive a signal indicating when the separable base portion (220) has been separated from the keyboard (215). In this example, the keyboard may include any sensing device that provides the signal to the processor (205) indicating the state of the separable base portion (220) relative to the keyboard (215).

In an example, the processor may determine the state of a first joystick (235) and a second joystick (240) relative to a mouse (230). In particular, the processor (205) may receive a signal indicating when the first joystick (235) and second joystick (240) have been separated from the mouse (230). In this example, the mouse (230) may include any sensing device that provides the signal to the processor (205) indicating the state of the first joystick (235) and second joystick (240) relative to the mouse (230).

The computing system (200) may include a display device (210). The display device (210) may be provided to allow a user of the computing system (200) to interact with computer readable program code executed by the processor (205) as described herein. The keyboard (215), separable base portion (220), and/or mouse (230) may also allow a user to interact with other peripheral devices coupled to the computing system (200) such as a printer or other media output devices. Examples of display devices (210) include any type of display device including cathode ray tubes, touchscreens, LED display devices, OLED display devices, and LCD display devices, among others. In this example, the display device (210) may be similar to a computer display device and may be similar or different from a touch-sensitive display device (225) of the separable base portion (220). In an example, the display device (210) is a distinct from the touch-sensitive display device (225).

The keyboard (215) may be any type of keyboard (215) that allows a user to interface with the processor (205) of the computing system (200). In some examples, the keyboard (215) may include a myriad of buttons that, when pushed, represent on the display device (210) numbers and letters. In some examples, the keyboard (215) may include dedicated buttons that relate to specific commands associated with operation of the computing system (200) such as volume keys, microphone mute keys, function keys (i.e., F1-F12), arrow keys, and other function-specific key available on a keyboard (215). In an example, the keyboard (215) is coupled to the display device (210) via a number of hinges so as to allow the display device (210) to be adjusted vertically at an angle relative to the keyboard (215). In an example, the keyboard (215) is removable from the display device (210) allowing the keyboard (215) and display device to work independently from each other. In this example, the display device (210) may include a stand or other structure used to present the display device (210) to a user for viewing.

The keyboard (215) also includes a separable base portion (220). As described herein, the separable base portion (220) may include a lower end of the keyboard (215) closest to the user. The separable base portion (220) may be coupled to the keyboard (215) using a number of selective coupling devices such as latches, magnets, clips, snaps, screws, and bolts, among others. However, the separable base portion (220) may be separated from the keyboard (215) allowing the user to operate the separable base portion (220) independent of the keyboard (215), display device (210), and/or processor (205) of the computing system (200). In an example, therefore, the separable base portion (220) may include a dedicated processor, data storage device, and graphics processing unit (GPU). Each of the dedicated processor, data storage device, and graphics processing unit (GPU) of the separable base portion (220) may operate either while the separable base portion (220) is coupled to the keyboard (215) or not. In an example, the dedicated processor, data storage device, and graphics processing unit (GPU) may cooperate with the processor (205) associated with the computing system (200) when the separable base portion (220) is coupled to the keyboard (215), but operate independent of the processor (205) of the computing system (200) when the separable base portion (220) is decoupled from the keyboard (215). In an example, the dedicated processor, data storage device, and graphics processing unit (GPU) of the separable base portion (220) may communicate with the processor (205) of the computing system (200) wirelessly when the separable base portion (220) is uncoupled from the keyboard (215).

As described herein, the separable base portion (220) may include a touch-sensitive display device (225). The touch-sensitive display device (225) may display any information to the user when the separable base portion (220) is either coupled or uncoupled from the keyboard (215). When the separable base portion (220) is uncoupled from the keyboard (215), the touch-sensitive display device (225) may present to a user any graphics and/or information associated with the execution of computer readable program code executed by the dedicated processor of the separable base portion (220) and/or the GPU of the separable base portion (220). The computer readable program code may be maintained on a data storage device associated with the separable base portion (220) such as a micro-SD card or other type of external or internal data storage device.

The computing system (200) may further include a mouse (230). The mouse (230) may be either a wired or wireless mouse (230) communicatively coupled to the processor (205) of the computing system (200). The mouse (230) also includes selectively removable first joystick (235) and second joystick (240) that form part of the mouse (230) when the mouse (230) is used as an input device to the processor (205) of the computing system (200). When removed from the mouse (230), the first joystick (235) and second joystick (240) may act, themselves, as input devices. In a particular example, the first joystick (235) and second joystick (240) may act as input to the dedicated processor of the separable base portion (220). This input to the dedicated processor of the separable base portion (220) may be irrespective of whether the separable base portion (220) is separated from the keyboard (215) or not.

In an example, the separable base portion (220) may first joystick (235) and second joystick (240) may be separated from the keyboard (215) and mouse (230) respectively. In this configuration, the user may interact with the touch-sensitive display device (225) of the separable base portion (220) using the first joystick (235) and second joystick (240). Thus, in this example, a signal may be presented to the processor of the computing system (200) and/or the dedicated processor of the separable base portion (220) indicating that the first joystick (235) and second joystick (240) have been separated from the housing of the mouse (230) and the dedicated processor of the separable base portion (220) is now to receive input from the first joystick (235) and second joystick (240). In an example, the first joystick (235) and second joystick (240) may each include a dedicated power supply such as a battery and a wireless communicator that enables the user to hold the first joystick (235) and second joystick (240) in his/her hands and provide input to the dedicated processor of the separable base portion (220).

In an example, the first joystick (235) and second joystick (240) may also or alternatively be physically coupled to the separable base portion (220) as described herein. In such an example, the separable base portion (220) may include mechanical and electrical coupling devices that allow the first joystick (235) and second joystick (240) to be mechanically and electrically coupled to the separable base portion (220). In an example, the mechanical and electrical interfaces may be positioned on an extreme left and right of the separable base portion (220) in order to receive the first joystick (235) and second joystick (240) respectively. In an example, the electrical interface provides a wired communication between the separable base portion (220) and the first joystick (235) and second joystick (240). In an example, the electrical interface may provide power from an internal battery of the separable base portion (220) to the first joystick (235) and second joystick (240).

The first joystick (235) and/or second joystick (240) may include a number of buttons or other type of user-actionable devices to relay instructions to the separable base portion (220). These include hard keys, soft keys, joysticks, and triggers, among other user-actionable devices. Each of these user-actionable devices may be accessible to the user when the first joystick (235) and/or second joystick (240) are coupled to or uncoupled from the separable base portion (220).

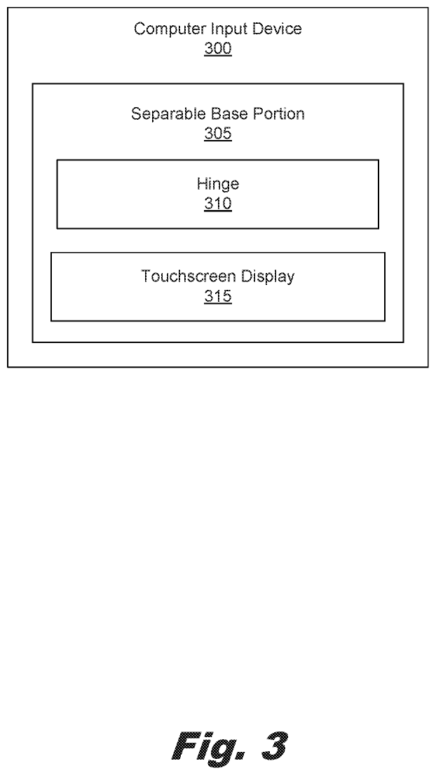

FIG. 3 is a block diagram of computer input device (300) according to an example of the principles described herein. The computer input device (300) may include a separable base portion (305) that includes a hinge (310) and a touchscreen display (315). As described herein, the hinges (310) allow for a portion of the separable base portion (305) to be folded onto itself reducing a dimensional size of the separable base portion (305). In an example, the hinges (310) when the separable base portion (305) is not in a foldable configuration, covers the mechanical and/or electrical interfaces used to interface the separable base portion (305) with a number of joysticks (FIG. 2, 235 and 240). When the separable base portion (305) is in a folded configuration, the mechanical and electrical interfaces may be exposed and presented for receipt of the number of joysticks (FIG. 2, 235 and 240).

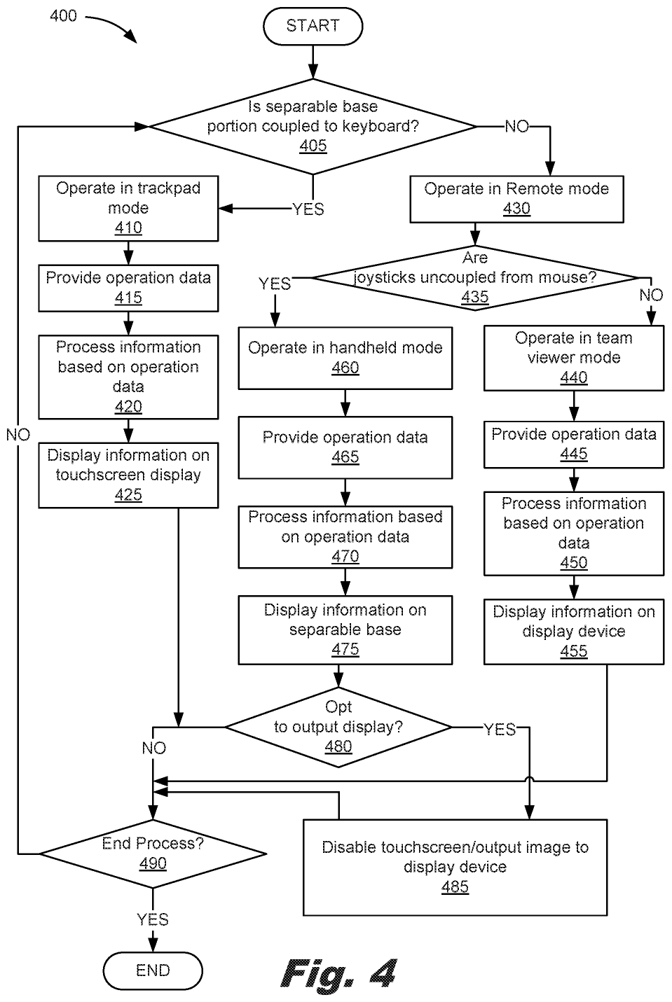

FIG. 4 is a flowchart showing a method (400) of determining a configuration state of a computing system according to an example of the principles described herein. The method (400) may start by determining (405) whether a separable base portion (FIG. 3, 305) is coupled to a keyboard (FIG. 2, 215). As described herein, a processor (FIG. 2, 205) of the computing system (FIG. 2, 200) may include a number of sensors on the keyboard (FIG. 2, 215) that can detect the presence or absence of the separable base portion (FIG. 3, 305) from the keyboard (215). When the separable base portion (FIG. 3, 305) is no longer detected at the keyboard (FIG. 2, 215), a signal may be sent to the processor (FIG. 2, 205) indicating as such.

Based on the determination (405) of whether the separable base portion (FIG. 3, 305) is coupled to the keyboard (FIG. 2, 215), the separable base portion (FIG. 3, 305) may operate in one of two modes. When the separable base portion (FIG. 3, 305) is coupled to the keyboard (FIG. 2, 215), the separable base portion (FIG. 3, 305) may operate (410) in a trackpad mode. In this trackpad mode, the separable base portion (FIG. 3, 305) may provide (415) operation data via a wired connection between the keyboard (FIG. 2, 215) and the separable base portion (FIG. 3, 305). Additionally, information may be processed (420) based on the operation data received from the separable base portion (FIG. 3, 305). Additionally, in some examples, information may be displayed (425) on the touchscreen display (FIG. 3, 315) of the separable base portion (FIG. 3, 305) as described herein. This information may include, among other information, icons depicting executable applications, status reports of battery life of the computing system (FIG. 2, 200), and other data associated with any executable program code being executed by the processor (FIG. 2, 205) of the computing system (FIG. 2, 200).

Based on the determination (405), when the separable base portion (FIG. 3, 305) is not coupled to the keyboard (FIG. 2, 215) (NO Determination, 405), the separable base portion (FIG. 3, 305) may operate (430) in a remote mode. The operation (430) of remote mode may include initiating execution of computer readable program code via the dedicated processor, data storage device, and graphics processing unit (GPU) of the separable base portion (FIG. 3, 305) as described herein. In this example, the separable base portion (FIG. 3, 305) may operate independent of the remaining computing system (FIG. 2, 200) devices.

The method (400) may the make a further determination (435) whether the first joystick (FIG. 2, 235) and/or second joystick (FIG. 2, 240) are uncoupled from the mouse (FIG. 2, 230). As described herein, the mouse (FIG. 2, 230) may include a sensor to detect whether the first joystick (FIG. 2, 235) and/or second joystick (FIG. 2, 240) are coupled, either mechanically or electrically, to the mouse (FIG. 2, 230). Such a signal from these sensors on the mouse (FIG. 2, 230) may be sent to and received by the processor (FIG. 2, 205) of the computing system (FIG. 2, 200). In an example, a signal (i.e., wireless signal) may be sent to the separable base portion (FIG. 3, 305) as well indicating that the first joystick (FIG. 2, 235) and/or second joystick (FIG. 2, 240) may be wirelessly or via a wire, coupled to the separable base portion (FIG. 3, 305).

When determining (435) whether the first joystick (FIG. 2, 235) and/or second joystick (FIG. 2, 240) are uncoupled from the mouse (FIG. 2, 230), in an example, the computing system (FIG. 2, 200) and/or the separable base portion (FIG. 3, 305) may determine whether a second set of first joystick (FIG. 2, 235) and/or second joystick (FIG. 2, 240) have been uncoupled from a second mouse. In this example, the computing system (FIG. 2, 200) and/or the separable base portion (FIG. 3, 305) may detect the presence of separated first joystick (FIG. 2, 235) and/or second joystick (FIG. 2, 240) on the second mouse via, for example, wireless communication. Upon detection that the first joystick (FIG. 2, 235) and/or second joystick (FIG. 2, 240) of the second mouse has been decoupled, the display device (FIG. 2, 210) and/or the touch-sensitive display device (225) of the separable base portion (FIG. 3, 305) may indicate to a user that there is the option to add these additional first joystick (FIG. 2, 235) and/or second joystick (FIG. 2, 240) as input devices. If the user selects to add the first joystick (FIG. 2, 235) and/or second joystick (FIG. 2, 240) of the second mouse as input devices to the computing system (FIG. 2, 200) and/or separable base portion (FIG. 3, 305), the computing system (FIG. 2, 200) and/or separable base portion (FIG. 3, 305) may begin to operate in multi-user mode such that two users may concurrently provide input to the computing system (FIG. 2, 200) and/or separable base portion (FIG. 3, 305). In the context where the processor of the either the computing system (FIG. 2, 200) or separable base portion (FIG. 3, 305) are executing a gaming application, the mode can be described as being a multi-player mode with the ability of each user to provide input to either one of the processors associated with the computing system (FIG. 2, 200) or the separable base portion (FIG. 3, 305). Although this example describes the inclusion of a single additional set of first joystick (FIG. 2, 235) and/or second joystick (FIG. 2, 240) as input devices, the present specification further contemplates the communicative coupling of any number of first joystick (FIG. 2, 235) and/or second joysticks (FIG. 2, 240) in order for any number of additional users to provide input to the computing system (FIG. 2, 200) and/or separable base portion (FIG. 3, 305).

Where the first joystick (FIG. 2, 235) and/or second joystick (FIG. 2, 240) are detected to be coupled to the mouse (FIG. 2, 230) (NO Determination, 435), the separable base portion (FIG. 3, 305) may operate (440) in a team viewer mode. The team viewer mode may allow operation data to be provided (445) to the processor (FIG. 2, 205) of the computing system (FIG. 2, 200), and the processor (FIG. 2, 205) of the computing system (FIG. 2, 200) to process (450) information based on that operation data. That information may then be displayed (455) on the display device (FIG. 2,210) of the computing system (200) allowing multiple users to see what a single user is manipulating with the mouse (FIG. 2, 230) (i.e., with first joystick (FIG. 2, 235) and/or second joysticks (FIG. 2, 240) coupled to the mouse (FIG. 2, 230)). In an example, the display device (FIG. 2,210) of the computing system (200) may be mirrored from the touchscreen display (FIG. 3, 315) of the separable base portion (FIG. 3, 305) in order to show an identical representation of information presented on the touchscreen display (FIG. 3, 315) of the separable base portion (FIG. 3, 305). In an example, the display device (FIG. 2,210) of the computing system (200) may be extended from the touchscreen display (FIG. 3, 315) of the separable base portion (FIG. 3, 305) in order to show an extended version of virtual space from that presented on the touchscreen display (FIG. 3, 315) of the separable base portion (FIG. 3, 305).

Where the first joystick (FIG. 2, 235) and/or second joystick (FIG. 2, 240) is not detected to be coupled to the mouse (FIG. 2, 230) (YES Determination, 435), the separable base portion (FIG. 3, 305) may operate (460) in a handheld mode. The handheld mode may be engaged in independent on whether the first joystick (FIG. 2, 235) and/or second joystick (FIG. 2, 240) are coupled to the separable base portion (FIG. 3, 305) or not. Where the first joystick (FIG. 2, 235) and/or second joystick (FIG. 2, 240) are not coupled to the separable base portion (FIG. 3, 305) and the separable base portion (FIG. 3, 305) is operating (460) in handheld mode, a wireless connection between the first joystick (FIG. 2, 235) and/or second joystick (FIG. 2, 240) and separable base portion (FIG. 3, 305) may be established using a wireless communication device and an energy source (i.e., batteries) of the first joystick (FIG. 2, 235) and/or second joysticks (FIG. 2, 240). Where the first joystick (FIG. 2, 235) and/or second joystick (FIG. 2, 240) are coupled to the separable base portion (FIG. 3, 305), power may be provided to the first joystick (FIG. 2, 235) and/or second joysticks (FIG. 2, 240) and the first joystick (FIG. 2, 235) and/or second joysticks (FIG. 2, 240) may communicate with the separable base portion (FIG. 3, 305) via a wired connection.

During operation (460) of the handheld mode, the operation data to be provided (460) to the dedicated processor of separable base portion (FIG. 3, 305), and the processor may process (470) information based on that operation data. That information may then be displayed (475) on the touchscreen display (FIG. 3, 315) of the separable base portion (FIG. 3, 305) allowing the user to intimately engage with the separable base portion (FIG. 3, 305) by manipulating the buttons on the first joystick (FIG. 2, 235) and/or second joysticks (FIG. 2, 240) communicatively coupled to the separable base portion (FIG. 3, 305). In an example, a user may opt out (480) of displaying the information on the touchscreen display (FIG. 3, 315) of the separable base portion (FIG. 3, 305). Where the user opts out (YES determination, 480) of displaying the information on the touchscreen display (FIG. 3, 315), the information may be automatically displayed (485) on the display device (FIG. 2, 210) of the computing system (FIG. 2, 200) while the touchscreen display (FIG. 3, 315) of the separable base portion (FIG. 3, 305) is disabled (485). This configuration may allow a user to couple the first joystick (FIG. 2, 235) and/or second joystick (FIG. 2, 240) to the separable base portion (FIG. 3, 305) while still, via a wireless communication between the separable base portion (FIG. 3, 305) and the computing system (FIG. 2, 200), displaying information to multiple persons on the display device (FIG. 2, 210).

Where the use does not opt out of displaying information on the touchscreen display (FIG. 3, 315) (NO determination, 480), the information may continue to be displayed (475) on the touchscreen display (FIG. 3, 315) of the separable base portion (FIG. 3, 305).

In any example, the process may be ended (490) by a number of actions by the user. Some examples include powering down of the separable base portion (FIG. 3, 305), powering down of the processor (FIG. 2, 205) of the computing system (FIG. 2, 200), recoupling of the separable base portion (FIG. 3, 305) to the keyboard (FIG. 2, 215), and recoupling of the first joystick (FIG. 2, 235) and/or second joysticks (FIG. 2, 240) to the mouse (FIG. 2, 230), among other actions.

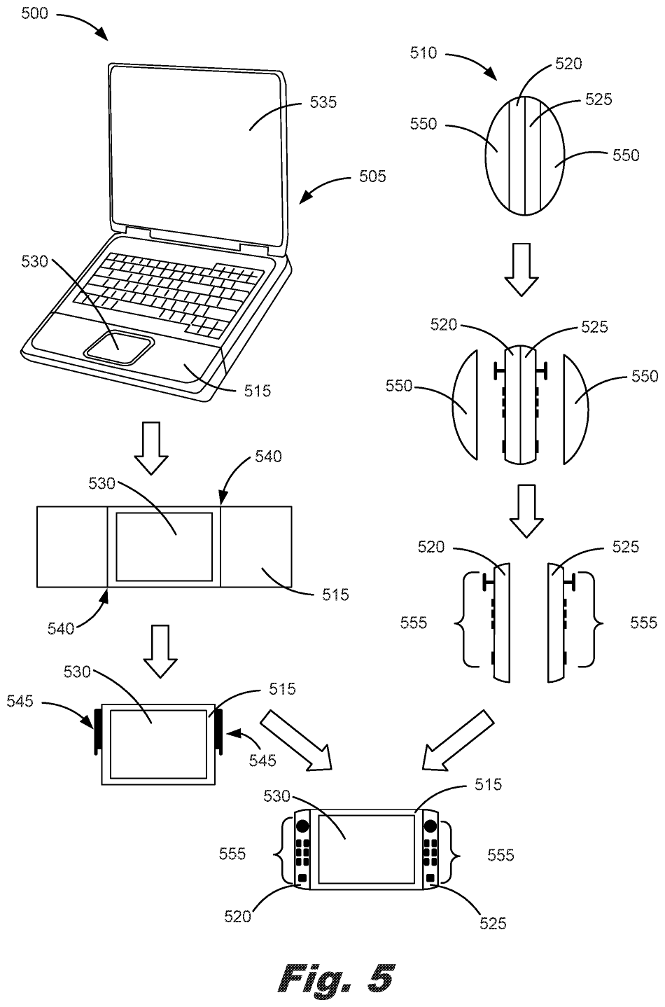

FIG. 5 is a block diagram of a computing system (500) according to an example of the principles described herein. The computing system (500) includes a computing device (505) and a mouse (510). FIG. 5 shows the disassembly of the computing device (505) and mouse (510) in order to combine a separable base portion (515) with a plurality of joysticks (520, 525).

In particular, the computing device (505) may include a separable base portion (515) selectively coupled thereto. The separable base portion (515) may include a touchscreen (530). The touchscreen (530) may serve as both a track pad and a secondary display device when coupled to the computing device (505).

The computing device (505) may include a processor and a data storage device. The processor of the computing device (505) may execute computer readable program stored on the data storage device to display information and images on the display device (535) of the computing device (505) as well as the touchscreen (530) as described herein.

The separable base portion (515) may include a dedicated processor that also executes computer readable program code independent of or in combination with the processor of the computing device (505). The separable base portion (515) may further include a data storage device to maintained computer executable program code to be executed by the dedicated processor of the separable base portion (515).

FIG. 5 shows the separable base portion (515) in a separated state from the computing device (505). The separable base portion (515), in an example and in the example shown in FIG. 5, includes a number of hinges (540) at which a portion of the separable base portion (515) may be folded onto itself. In this example, by folding the portion of the separable base portion (515) onto itself at the hinges (540), a joystick interface (545) may be exposed for coupling of one of the plurality of joysticks (520, 525) thereto.

The computing system (500), as described herein, may include a mouse (510). The mouse (510) may include a number of integral parts which include the joysticks (520, 525) described herein. In the example shown in FIG. 5, the joysticks (520, 525) form an internal body of the mouse (510). However, other examples include the joysticks (520, 525) forming any portion of the mouse (510) including internal parts. The present specification therefore contemplates a mouse (510) from which a portion of the mouse (510) may be removed to be used as the joysticks (520, 525) described herein. Any remaining portions (550) of the mouse (510) may be maintained near the computing device (505) so that they be made available for reassembly with the joysticks (520, 525) when the separable base portion (515) is no longer to be used by the user.

The joysticks (520, 525) may each include a number of buttons, joysticks, or any other actuatable device that a user may interact with. These may refer to generally as actuatable devices (555). In an example, the joysticks (520, 525) may be operable with the separable base portion (515) while either coupled to the separable base portion (515) or not. In an example, the joysticks (520, 525) may communicate with the separable base portion (515) via either a wireless communication device or a wired communication device as described herein.

Any data storage device described herein may include various types of memory modules, including volatile and nonvolatile memory. For example, the data storage device of the present example (i.e., the computing device (505) and/or separable base portion (515)) includes Random Access Memory (RAM), Read Only Memory (ROM), and Hard Disk Drive (HDD) memory. Many other types of memory may also be utilized, and the present specification contemplates the use of many varying type(s) of memory in the data storage device as may suit a particular application of the principles described herein. In certain examples, different types of memory in the data storage device may be used for different data storage purposes. For example, in certain examples the processor of the computing device (505) and/or the separable base portion (515) may boot from Read Only Memory (ROM), maintain nonvolatile storage in the Hard Disk Drive (HDD) memory, and execute program code stored in Random Access Memory (RAM).

The data storage devices described herein may include a computer readable medium, a computer readable storage medium, or a non-transitory computer readable medium, among others. For example, the data storage device may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The computing device (505) and/or separable base portion (515) may include various hardware adapters that enable the processors of the computing device (505) and/or separable base portion (515) to interface with various other hardware elements, external and internal to the computing device (505) and/or separable base portion (515). For example, the peripheral device adapters may provide an interface to input/output devices, such as, for example, a display device, the mouse (510), or a keyboard associated with the computing device (505). The peripheral device adapters may also provide access to other external devices such as an external storage device, a number of network devices such as, for example, servers, switches, and routers, client devices, other types of computing devices, and combinations thereof.

The computing device (505) and/or separable base portion (515) may further include a graphics processing unit (GPU) used to process data in order to present images on either the display device (535) and/or touchscreen (530) as described herein. In any example presented herein, the GPUs of either the display device (535) of the computing device (505) or the touchscreen (530) of the separable base portion (515) may cause wireless signals to be sent to each other in order to present information on either of the touchscreen (530) or display device (535).

The computing device (505) and/or separable base portion (515) may further include any type of output device as well to provide a user with output information. Such output devices may include printing devices and speakers, among others. Either of the separable base portion (515) and/or computing device (505) may include a tactile output device such as a haptic feedback device or vibrator that provides output to the user. These additional output devices may allow a user to further immerse him or herself into the experience of interacting with the separable base portion (515) and/or computing device (505).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of the computing device (505) and/or separable base portion (515) or other programmable data processing apparatus to produce a machine, such that the computer usable program code, when executed, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a computing device that includes a removable and stand-alone separable base portion that a user may remove from the computing device and interact with. The mouse may include a number of joysticks that may allow a user to interact with the separable base portion and may, in an example, allow a user to couple the joysticks thereto. The information presented at the touchscreen of the separable base portion may also be presented on a display device of the computing device. This information may mirror that information presented on the touchscreen or may be an extension of the touchscreen. With the dual touchscreen and display device as described herein, a user may selectively prevent and broadcast visual output via the separable base portion and/or computing device. This may broaden the use of these devices while still provide for relatively ease of mobility of the computing system. Still further, the processing devices of the computing device and separable base portion may interact with each other to provide a myriad of cooperative and independent processing of information as described herein. Indeed, with the multiple processors and/or GPUs described herein, one of the display device or touchscreen may be used as an extended desktop thereby allowing one of the display device or touchscreen to be used as a portable extended screen.

The preceding description has been presented to illustrate and describe examples of the principles described. This description is not intended to be exhaustive or to limit these principles to any precise form disclosed. Many modifications and variations are possible in light of the above teaching.

What is claimed is:

1. A computer input device, comprising:
a keyboard base comprising a touch-sensitive display device, the keyboard base being selectively removable from a keyboard;
a joystick couplable to the touch-sensitive display device.

2. The computer input device of claim 1, wherein the keyboard base is foldable along a hinge formed in the keyboard base.

3. The computer input device of claim 2, where the joystick is couplable to the keyboard base when the keyboard base is folded.

4. The computer input device of claim 1, wherein the joystick is removable from a mouse device associated with the computer input device.

5. The computer input device of claim 1, wherein the joystick comprises two joysticks removed from a body of a mouse associated with the computer input device, each of the joysticks being couplable to a side of the touch-sensitive display device.

6. The computer input device of claim 1, the keyboard base comprising a processing device to execute computer readable program code.

7. A computing system, comprising:
a processor;
a display device;
a keyboard selectively coupled to the display device;
a separable base portion of the keyboard comprising a touch-sensitive display device; and
a mouse comprising a first and second removable joysticks.

8. The computing system of claim 7, where in the separable base portion of the keyboard comprises two hingeable joints to reduce a dimension of the separable base portion.

9. The computing system of claim 8, wherein a surface on the separable base portion exposed by the hingeable joint include a mechanical and electrical interface to interface with the first and second removable joysticks.

10. The computing system of claim 7, wherein the separable base portion comprises a processor to execute computer readable program code when separated from the keyboard.

11. The computing system of claim 7, the mouse comprising a sensor to sense the removal of the first and second joysticks from the mouse and send a signal to the processor.

12. The computing system of claim 7, where the processor receives a signal from a sensor on the keyboard when the separable base portion of the keyboard is separated from the keyboard.

13. A keyboard, comprising:
a separable base portion, the separable base portion being electrically and mechanically couplable to the keyboard, wherein the separable base portion comprises a hinge to fold the separable base portion on itself; and
a touchscreen display formed on a portion of the separable base portion;
wherein folding a portion of the separable base portion exposed by folding the separable base portion at the hinge exposes a mechanical interface to receive a joystick.

14. The keyboard of claim 13, wherein the separable base portion comprises a processor to execute computer readable program code when separated from the keyboard.

15. The keyboard of claim 13, wherein an interface between the separable base portion and the keyboard includes a sensor and wherein when the separable base portion is removed from the keyboard a signal is sent to a processor of a computing device associated with the keyboard.
